(19) United States
(12) Patent Application Publication
(10) Pub. No.: US 2013/0282903 A1
(43) Pub. Date: Oct. 24, 2013

(54) METHOD, SYSTEM AND APPARATUS FOR ACCESSING A COMMUNICATIONS NETWORK

(71) Applicant: Michael Joseph DeLuca, Boca Raton, FL (US)

(72) Inventor: Michael Joseph DeLuca, Boca Raton, FL (US)

(73) Assignee: Research in Motion Limited, Waterloo (CA)

(21) Appl. No.: 13/452,147

(22) Filed: Apr. 20, 2012

(51) Int. Cl. G06F 15/173

(52) U.S. Cl. 709/225

(57) ABSTRACT

A method, system and apparatus for accessing a communications network are provided. A device determines that an access point to a first communications network is accessible via a first communications interface of the device. The device transmits a message to a second device connected via a second communications interface of the device that is different from the first communications interface, the message for causing the second device to access the first communications network via the access point.

### FIELD

The specification relates generally to mobile electronic devices, and specifically to a method, system and apparatus for accessing a communications network.

### BACKGROUND

The use of mobile electronic device (such as, but not limited to, electronic devices, communications devices, computing devices, personal computers, laptop computers, portable electronic devices, mobile computing device, portable computing devices, tablet computing devices, laptop computing devices, desktop phones, telephones, personal digital assistants PDAs, cellphones, smartphones, e-reader, Internet-enabled appliances and the like) is becoming widespread. It is well-known to include calendaring, contacts, messaging, and/or other functions in mobile electronic devices. More recently, there has been an increase in the number and type of applications that are configured to the unique form factors and computing environments of mobile electronic devices.

### BRIEF DESCRIPTIONS OF THE DRAWINGS

For a better understanding of the various implementations described herein and to show more clearly how they may be carried into effect, reference will now be made, by way of example only, to the accompanying drawings in which like reference numbers refer to substantially similar items throughout.

FIG. 1 depicts a system for accessing a communications network, according to non-limiting implementations.

FIG. 2 depicts a method for accessing a communications network, according to non-limiting implementations.

FIG. 3 depicts the system of FIG. 1 with credentials being received at a first device, according to non-limiting implementations.

FIG. 4 depicts the system of FIG. 1 with a connection between devices being established, according to non-limiting implementations.

FIG. 5 depicts the system of FIG. 1 with a message for causing a second device to access a first communications network via an access point being transmitted from the first device to the second device, according to non-limiting implementations.

FIG. 6 depicts the system of FIG. 1, the second device accessing the first communications network via the access point, according to non-limiting implementations.

FIG. 7 depicts a system for accessing a communications network with a record of credentials having been previously received at a second device being stored at a first device, according to non-limiting implementations.

FIG. 8 depicts the system of FIG. 7 with a message for causing a second device to access a first communications network via an access point being transmitted from the first device to the second device without credentials for accessing the access point, according to non-limiting implementations.

FIG. 9 depicts a system comprising a plurality of devices, each of which can be caused to access a communications network, by propagating a message from device to device, the message for causing each device to access the communications network via an access point from device to device, according to non-limiting implementations.

### DETAILED DESCRIPTION

The present disclosure pertains to facilitating access to a communications network. Specific embodiments described herein relate to coordinating access to an access point of a communications network by an associated plurality of mobile electronic devices, including at least a first device and a second device. In various implementations described in this disclosure, a first device may cause a second device to access a communications network. In one embodiment, the first device causes the second device to access the communications network based upon a determination by the first device that the communications network is accessible.

In certain aspects, the disclosure includes systems, methods, and apparatuses in a first device. The first device may determine that an access point to a first communications network is accessible via a first communications interface of the first device. A message may be transmitted from the first device to a second device to causing the second device to access the first communications network via the access point. In certain aspects, the message may be transmitted from the first device to the second device via a second communications interface of the first device that is different from the first communications interface.

In certain aspects, the disclosure includes systems, methods, and apparatuses in a second device. The second device may receive a message from a first device, which causes the second device to access a communications network via an access point. In certain aspects, the message is received from the first device via a first communications interface with a connection to the first device. The first communications interface of the second device may be different from a second communications interface used to connect to the communications network.

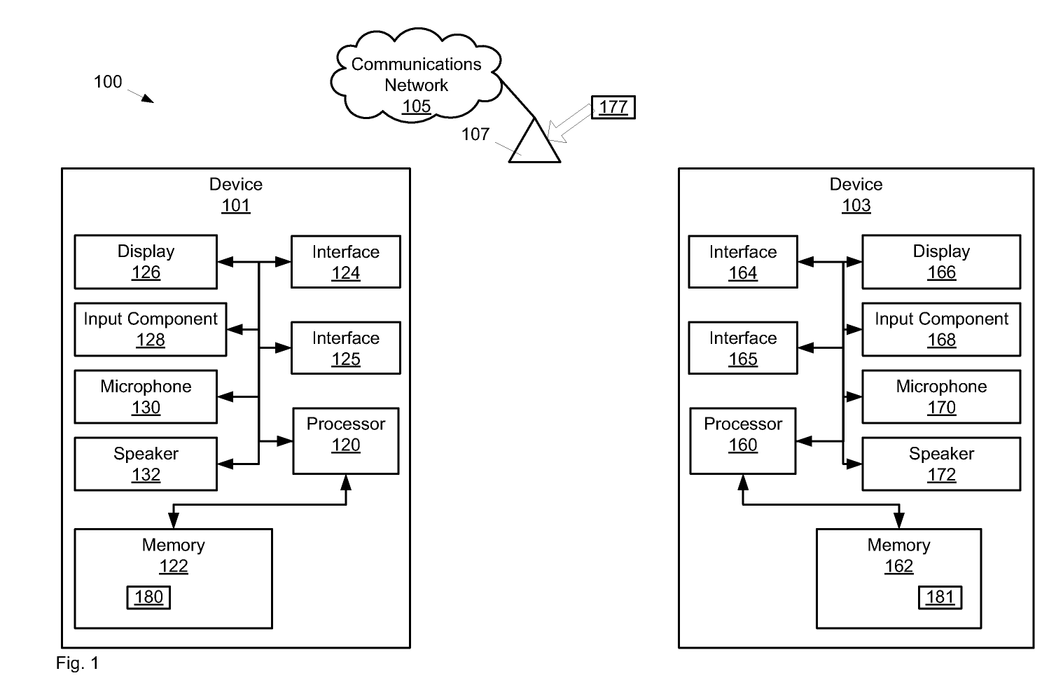

FIG. 1 depicts a system 100 comprising a first device 101 and a second device 103, a communications network 105 and an access point 107, according to non-limiting implementations. In this disclosure, first device 101 may be interchangeable referred to hereafter as device 101 and second device may be interchangeably referred to hereafter as device 103. Communications network 105 may be interchangeable referred to hereafter as network 105.

Device 101 can be any type of mobile electronic device that can be used in a self-contained manner to access communications network 105 via an access point. Examples of device 101 include, but are not limited to, any suitable combination of electronic devices, communications devices, computing devices, personal computers, laptop computers, portable electronic devices, mobile computing device, portable computing devices, tablet computing devices, laptop computing devices, desktop phones, telephones, PDAs (personal digital assistants), cellphones, smartphones, e-reader, Internet-enabled appliances and the like. Other suitable devices are within the scope of present implementations. In addition to accessing communications network 105 via an access point, device 101 is capable of communicating with other mobile electronic devices, such as device 103.

Similarly, device 103 can be any type of mobile electronic device that can be used in a self-contained manner to access communications network 105 via an access point. Examples of device 101 include, but are not limited to, any suitable combination of electronic devices, communications devices, computing devices, personal computers, laptop computers, portable electronic devices, mobile computing device, portable computing devices, tablet computing devices, laptop computing devices, desktop phones, telephones, PDAs (personal digital assistants), cellphones, smartphones, e-reader, Internet-enabled appliances and the like. Other suitable devices are within the scope of present implementations. In addition to accessing communications network 105 via an access point, device 103 is capable of communicating with other mobile electronic devices, such as device 101.

Device 101 comprises a processor 120 interconnected with a memory 122, a first communications interface 124, a second communications interface 125, a display 126 and an input component 128, and optionally a microphone 130 and speaker 132. In this disclosure, first communications interface 124 may be interchangeably referred to hereafter as interface 124 and second communications interface 125 may be interchangeably referred to hereafter as interface 125. Similarly device 103 comprises a processor 160 interconnected with a memory 162, a first communications interface 164, a second communications interface 165, a display 166 and an input component 168, and optionally a microphone 170 and speaker 172. In this disclosure, first communications interface 164 may be interchangeably referred to hereafter as interface 164 and second communications interface 165 may be interchangeably referred to hereafter as interface 165.

In one embodiment, device 101 is configured to: determine that access point 107 to network 105 is accessible via interface 124; and transmit a message to device 103 connected via interface 125, the message for causing device 103 to access network 105 via access point 107, as will presently be explained. In another embodiment, device 103 is configured to: receive the message from device 101 via interface 165; and access network 105 via access point 107.

As shown in FIG. 1, communications network 105 is accessible via an access point 107. Access point 107 can comprise any suitable access point to network 105, including but not limited to any suitable combination of wireless access points, wireless devices, cell-phone access points, cellular network access points (including but not limited to 2G, 2.5G, 3G, 4G+, and the like), WiFi access points, WiMax access points, packet switching wireless access points, radio access network relays, analog network access points, PSTN (public switched telephone network) access points, and the like.

It is further appreciated that access point 107 may be associated with credentials 177 comprising any suitable data for establishing a connection between one or more of devices 101, 103 and access point 107, such that communications with access point 107 can occur. In example implementations, credentials 177 may be required by the access point 107 prior to providing connectivity to the communications network 105, or alternative may be required by by the access point 107 prior to establishing a user plane wireless connection between the access point 107 and one or more devices 101, 103. Examples of credentials 177 may include, but are not limited to: a WiFi profile, a WiMax profile, an identifier of access point 107, a network identifier, SSID (Service Set Identifier) data, wireless type data, passwords, access data, encryption data, encryption keys, decryption keys, WEP (Wired Equivalent Privacy) keys, certification data, certificates, address information and the like. In some implementations, access point 107 can comprise a WiFi access point and hence credentials 177 can comprise any suitable data for communicating with a WiFi access point.

It is yet further appreciated that access point 107 can be configured to transmit (e.g. broadcast or unicast) at least a portion of credentials 177. For example, the access point 107 may transmit an identifier of access point 107, such as SSID data, such that one or more of devices 101, 103 can determine that access point 107 is present and available to provide access to communications network 105.

It is appreciated that FIG. 1 further depicts a schematic diagram of device 101 according to non-limiting implementations. It should be emphasized that the structure of device 101 in FIG. 1 is purely an example, and contemplates a device that can be used for both wireless voice (e.g. telephony) and wireless data communications (e.g. email, web browsing, text, and the like). However, while FIG. 1 contemplates a device that can be used for telephony, in other implementations, device 101 can comprise a device configured for implementing any suitable specialized functions, including but not limited to one or more of telephony, computing, appliance, and/or entertainment related functions.

Device 101 comprises at least one input component 128 generally configured to provide a human machine interface, and can comprise any suitable combination of input components. Examples of input components include, but are not limited to a keyboard, a keypad, a pointing device, a mouse, a track wheel, a trackball, a touchpad, a touch screen, motion sensors, camera apparatus, infrared detectors, peripheral accessories, and the like. Input component 128 may be included in device 101 (as shown) or may be an external peripheral component connected to device 101 via a wired or wireless connection and which provides a human machine interface to device 101. Other suitable input components are within the scope of present implementations.

Input from input component 128 is received at processor 120 (which can be implemented as a plurality of processors, including but not limited to one or more central processors (CPUs)). Processor 120 is configured to communicate with a memory 122 comprising a non-volatile storage unit (e.g. Erasable Electronic Programmable Read Only Memory (“EEPROM”), Flash Memory) and a volatile storage unit (e.g. random access memory (“RAM”)). Programming instructions that implement the functional teachings of device 101 as described herein are typically maintained, persistently, in memory 122 and used by processor 120 which makes appropriate utilization of volatile storage during the execution of such programming instructions. Those skilled in the art will now recognize that memory 122 is an example of computer readable media that can store programming instructions executable on processor 120. Furthermore, memory 122 is also an example of a memory unit and/or memory module.

Processor 120 in turn can also be configured to communicate with a display 126, and optionally a microphone 130 and a speaker 132. Display 126 comprises any suitable one of or combination of CRT (cathode ray tube), flat panel displays (e.g. LCD (liquid crystal display), plasma, OLED (organic light emitting diode)), capacitive or resistive touchscreens, video projection apparatus, and the like. The display 126 may be included as part of device 101 (as shown) or may be an external peripheral display which is controlled by device 101 via wired or wireless connections. Microphone 130, when present, comprises any suitable microphone for receiving sound data. Speaker 132, when present, comprises any suitable speaker for providing sound data, audible alerts, audible communications from remote communication devices, and the like, at device 101.

In some implementations, input component 128 and display 126 are external to device 101, with processor 120 in communication with each of input component 128 and display 126 via a suitable connection and/or link.

Processor 120 also connects to interface 124, which can be implemented as one or more radios configured to communicate with access point 107. In general, it will be appreciated that interface 124 is configured to correspond with the network architecture that is used to implement access point 107. For example, interface 124 can comprises a wireless interface configured to communicate with access point 107, including but not limited to any suitable combination of wireless devices, wireless access interfaces, cell-phone interfaces, cellular network interfaces (including but not limited to 2G, 2.5G, 3G, 4G+ interfaces, and the like), WiFi interfaces, WiMax interfaces, packet switching wireless access points, radio access network relays, analog network interfaces, PSTN (public switched telephone network) interfaces, and the like.

Processor 120 also connects to interface 125, which can be implemented as one or more radios configured to communicate with device 103. In general, it will be appreciated that interface 125 is configured to correspond with the network architecture that is used to communicate with device 103. For example, interface 125 can comprises any suitable combination of wired and/or wireless interfaces for communication with device 103, including but not limited to any suitable combination of USB (universal serial bus) cables, serial cables, Bluetooth™ interfaces, Zigbee™ interfaces, NFC (near field communication) interfaces, DLNA (Digital Living Network Alliance) interfaces, UPnP (Universal Plug aNd Play) interfaces, WiFi interfaces, WiMax interfaces, packet switching wireless access points, radio access network relays, analog network interfaces, PSTN (public switched telephone network) interfaces, and the like.

In particular, it is appreciated that interface 125 is different from interface 124. In a non-limiting example, interface 124 can comprise a WiFi interface and interface 125 can comprise a Bluetooth™ interface, however any suitable combination of communications interfaces is within the scope of present implementations.

In particular, it is appreciated that memory 122 stores an application 180 for accessing network 105. When processor 120 processes application 180, processor 120 is configured to: determine that access point 107 to network 105 is accessible via interface 124; and transmit a message to device 103 connected via interface 125, the message for causing device 103 to access network 105 via access point 107.

It is appreciated that FIG. 1 further depicts a schematic diagram of device 103 according to non-limiting implementations. It should be emphasized that the structure of device 103 in FIG. 1 is purely an example, and that the example device can be used for both wireless voice (e.g. telephony) and wireless data communications (e.g. email, web browsing, text, and the like). However device 103 can be alternatively configured with any suitable specialized functions, including but not limited to one or more of telephony, computing, appliance and entertainment functions. It is appreciated that elements of device 103 can be substantially similar to elements of device 101 described above. For example, processor 160, memory 162, interface 164, interface 165, display 166, input component 168, optional microphone 170, and optional speaker 172 can be respectively similar to processor 120, memory 122, interface 124, interface 125, display 126, input component 128, optional microphone 130, and optional speaker 132. In particular, it is appreciated that memory 162 stores an application 181 (which may be represented in memory 162 as computer readable instructions) for accessing network 105. When processor 160 executes application 181 (such as when the processor 160 processes the computer readable instructions), the application 181 causes the processor 160 to: receive a message from device 101 via interface 165, the message for causing interface 164 to access a network 105 via access point 107, the message received from device 101 without requesting the message; and access network 105 via access point 107.

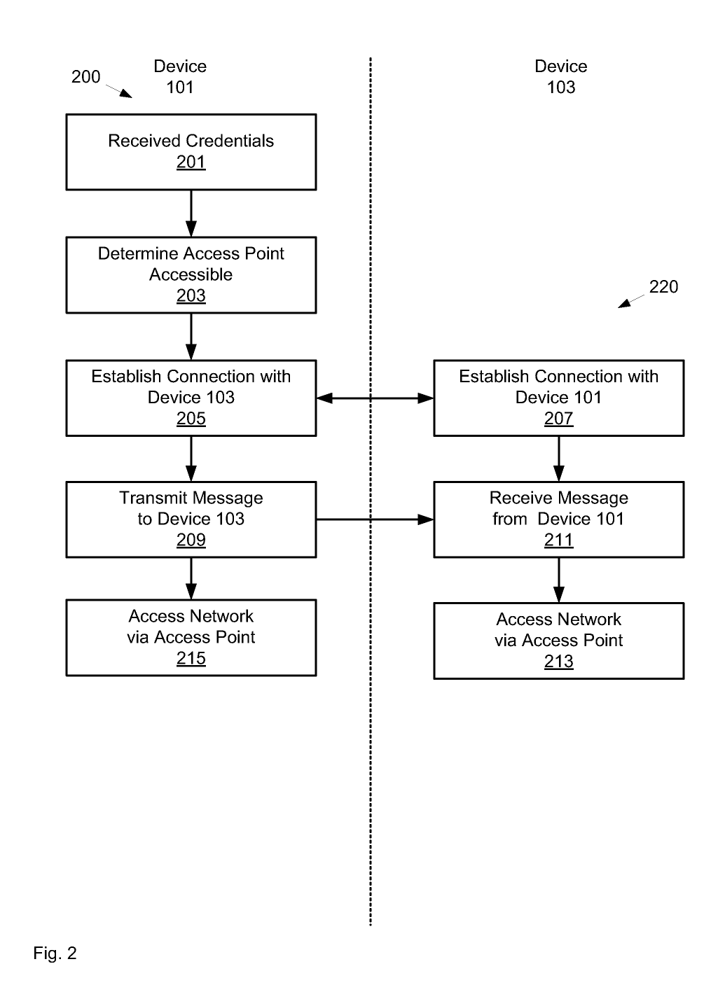

Attention is now directed to FIG. 2 which depicts a first method 200 associated with device 101 and a second method 220 associated with device 103, according to non-limiting implementations. In order to assist in the explanation of methods 200, 220, it will be assumed that each of methods 200 and 220 may be performed in system 100 of FIG. 1. Furthermore, the following discussion of FIG. 2 will lead to a further understanding of system 100 and its various components. However, it is to be understood that system 100 and/or methods 200,220 can be varied, and need not necessarily work exactly as discussed herein in conjunction with each other, and that such variations are within the scope of present implementations.

It is appreciated that, in some implementations, method 200 and second method 220 occurs in system 100 by respective processors 120, 160 of devices 101, 103. Indeed, method 200 and second method 220 is one way in which devices 101, 103 can be configured. It is to be emphasized, however, that method 200 and second method 220 need not be performed in the exact sequence as shown, unless otherwise indicated; and likewise various blocks may be performed in parallel rather than in sequence; hence the elements of method 200 and second method 220 are referred to herein as “blocks” rather than “steps”. It is also to be understood, however, that method 200 and second method 220 can occur on variations of system 100 as well.

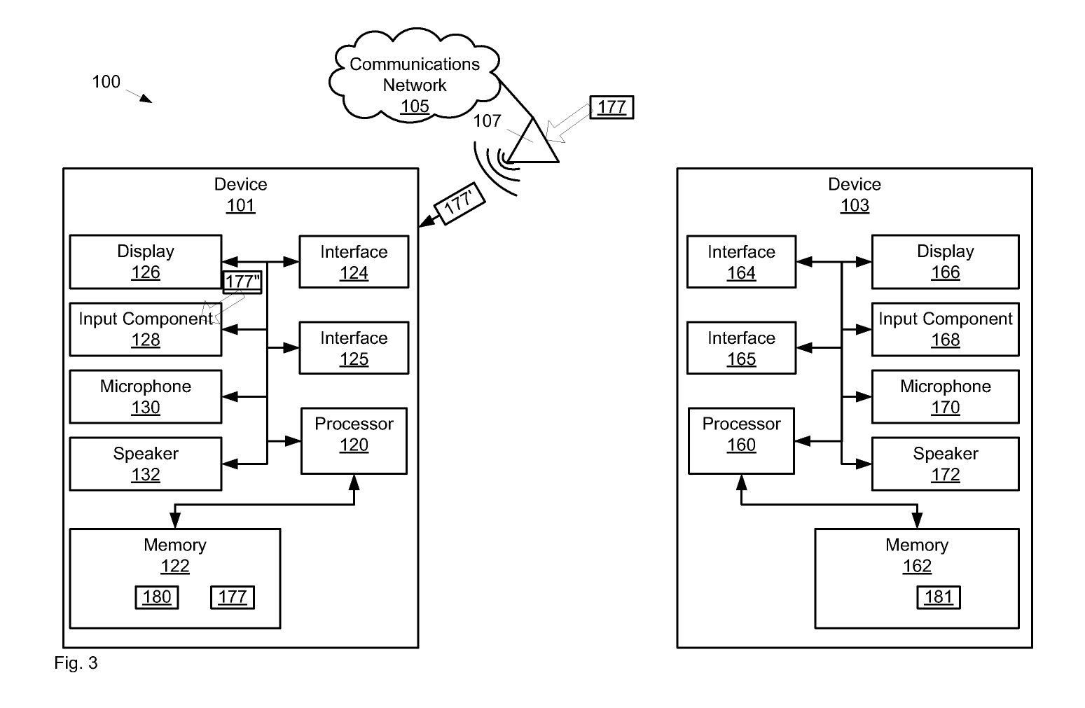

Further, the following discussion of method 200 and second method 220 will be done with reference to FIGS. 3-6, each of which are substantially similar to FIG. 1 with like elements having like numbers.

At block 201, device 101 acquires credentials 177 for accessing network 105 via access point 107. In the described example, device 101 acquires the credentials 177 from one or more of: access point 107 (e.g. SSID broadcast); input component 128 (e.g. human machine interface); access to memory 122 (e.g. new SIM inserted, removable media, etc); and a receiving a communication from another machine (not shown). However, it is appreciated that any suitable method of acquiring credentials is within the scope of present implementations. For example, credentials 177 may be acquired via receipt from an NFC (near filed communications) tag (e.g. device 101 could obtain semi-private credentials from an NFC tag at a venue so that device 101 can be auto-configured for access to a the venue WiFi). In a further example, credentials 177 could be acquired at device 101 via receipt of a wireless communications network message (e.g. short message service, SMS, text message or a cellular network configuration message); in some implementations receipt of such a network message can force device 101 to connect to an IP network (e.g. using emergency public credentials provided in the network message). In yet a further example, a flash card (e.g. a subscriber identity module, SIM, microSD secure digital card, and the like) storing credentials 177 could be inserted at device 101 which may, in some implementations, trigger a connection with access point 107.

However, in depicted examples, with reference to FIG. 3, device 101 can acquire a first subset 177′ of credentials 177 from access point 177 via interface 124, and a second subset 177″ of credentials 177 via input component 128. Indeed, in implementations where access point 177 comprises a WiFi access point, first subset 177′ can comprise SSID data broadcast by access point 107 and received at device 101 thereby identifying access point 107. Further second subset 177″ may comprise a password for connecting with access point 107. Indeed, consider a scenario where device 101 is transported within a broadcast distance of access point 107, and SSID data (i.e. subset 177′) is detected, but access point 107 is password protected. In some implementations, device 101 may provide a prompt at display 126 for entering the password (i.e. subset 177″) such that device 101 can access network 105 via access point 107.

In any event, subsets 177′, 177″ are stored as credentials 177 at memory 122. It is hence further appreciated that memory 122 is configured to store credentials 177 such that device 101 can access network 105 via access point 107.

However, in other implementations, it is appreciated that credentials 177 can be acquired at device 101 entirely from access point 107, for example when access point transmits (e.g. broadcast signal or unicast message) credentials 177.

In yet further implementations, credentials 177 can be acquired entirely from input component 128; for example, device 101 can provide a prompt at display 126 for entering SSID data (subset 177′) and a password (i.e. subset 177″) such that device 101 can access network 105 via access point 107.

In yet further implementations credentials 177 can be acquired from another device, for example via e-mail, SMS (short message service), Bluetooth™ connections and the like.

It is yet further appreciated that device 101 need not be within a broadcast range of access point 107 to acquire credentials. Indeed, is further appreciated that credentials 177 can have been previously acquired at device 101 using any suitable process.

In any event, any suitable process for acquiring credentials 177 at device 101 is within the scope of present implementations.

Returning to FIG. 2, at block 203, device 101 determines that access point 107 to network 107 is accessible via interface 124. For example, device 101 can determine that access point 107 is accessible upon receipt of subset 177′ and/or data 177. It is appreciated that in implementations where a password (i.e. subset 177″) is used to access point 107, the password need not be received at device 101 for device 101 to determine that access point 107 is accessible. In other words, device 101 need not access access point 107 to determine that access point 107 is accessible. For example, device 101 may detect a signal from access point 107, which may be interpreted by device 101 to determine that the access point 107 is within an acceptable range to be accessible by device 101.

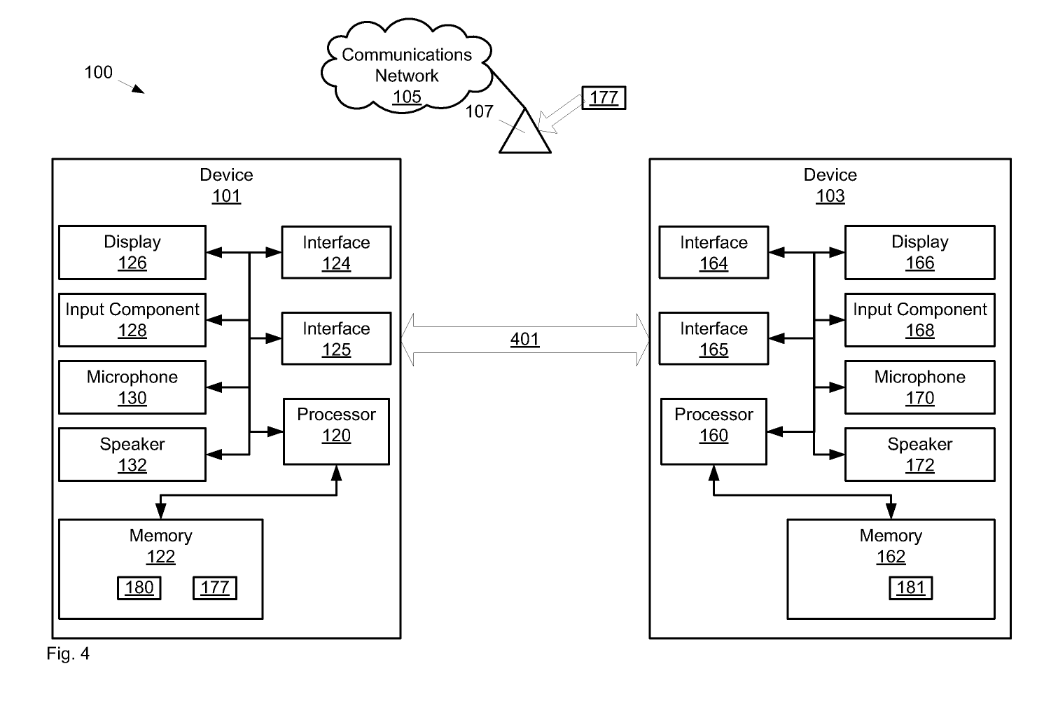

At blocks 205, and with further reference to FIG. 4, device 101 connects with device 103 via second communications interface 125; specifically, interface 125 of device 101 can connect with interface 165 of device 103. Similarly, at block 207, device 103 connects with device 101 via second communications interface 125; specifically, interface 165 of device 103 can connect with interface 125 of device 101.

For example, interfaces 125, 126 can connect via a connection 401 which comprises any suitable combination of a wired and/or wireless connections, including but not limited to any suitable combination of USB (universal serial bus) cables, serial cables, Bluetooth™ connections, Zigbee™ connections, NFC (near field communication) connections, DLNA (Digital Living Network Alliance) connections, UPnP (Universal Plug aNd Play) connections, WiFi connections, WiMax connections, packet switching wireless access points, radio access network relays, analog network connections, PSTN (public switched telephone network) connections, and the like. In any event, it is appreciated that connection 401 is different from any connections with access point 107. For example, connection 401 can comprise a Bluetooth™ connection and access point 107 can comprise a WiFi access point. In some implementations, connection 401 comprises a second communications network different from network 105. For example, network 105 can comprise a local communications network, a LAN (local area network), a wireless network, a WAN (wireless area network), a Bluetooth™ network, and the like. In some implementations, a portion of connection 401 can be over network 105, however using an access point different from access point 107.

It is further appreciated that device 101 can connect with device 103 via interface 125 when it is determined that access point 107 is accessible. For example, connection 401 can be established when it is determined that access point is accessible. However, in other implementations, device 101 can connect with device 103 via interface 125 before it is determined that access point 107 is accessible. For example, connection 401 can be established before it is determined that access point is accessible. In other words, when connection 401 comprises a wired connection, connection 401 may be established when a cable is connected between devices 101, 103. When connection 401 comprises a wireless connection, connection 401 can be established when devices 101, 103 are within a connection range of one another. However, when connection 401 is established via intervening devices (such as any suitable communications network), connection 401 can be established when one or more of devices 101, 103 transmit a request to the other of devices 101, 103 that connection 401 be established. Connection 401 may represent a communications session (including, for example, a secure communications session) between devices 101 and 103 as session endpoints.

Further, connection of devices 101, 103 can be initiated at either or both of devices 101, 103. However, in particular implementations, device 101 initiates connection 401 with device 103 via interface 125 when it is determined that access point 107 is accessible. In other words, in particular implementations of method 200, the performance of block 203 causes block 205 to be initiated.

However, in other implementations, block 205 may be performed before and/or during the performance of either of blocks 201, 203. For example, a communication session between device 101 and device 102 may be established so that if device 101 subsequently receives credentials at block 201 and determines that access point is accessible at block 203, the rest of the method 200 and second method 220 may be performed.

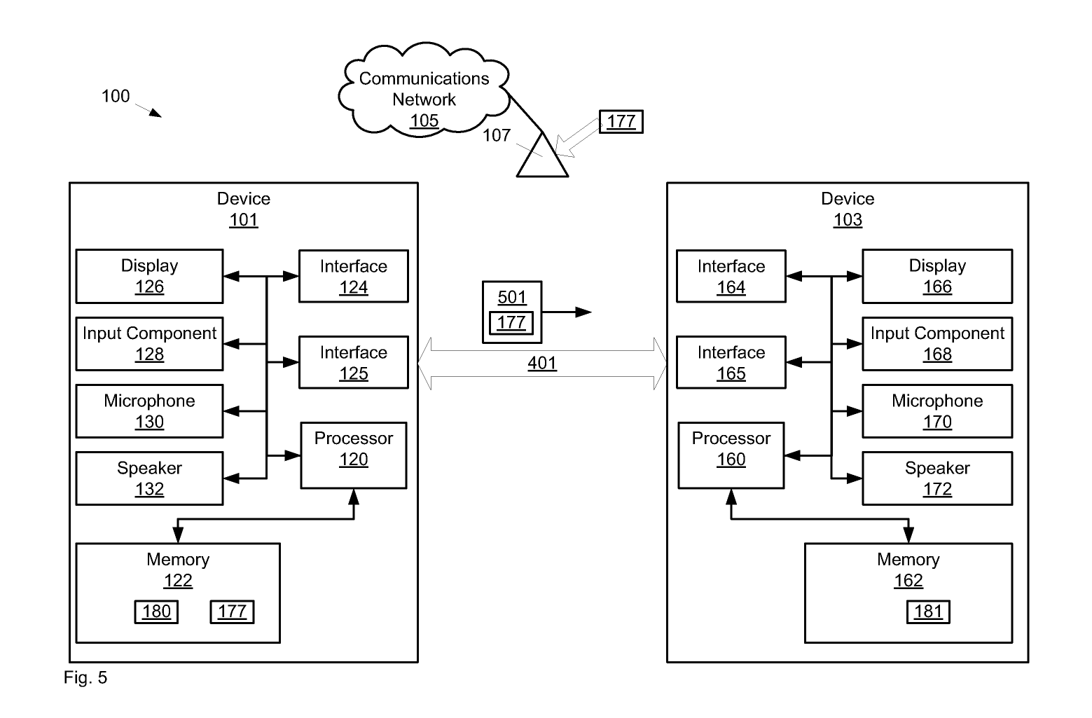

Returning to FIG. 2, and with further reference to FIG. 5, at block 207 device 101 transmits a message 501 to device 103 connected via interface 125, message 501 for causing device 103 to access network 105 via access point 107. Device 101 can transmit message 501 when it is determined that access point 107 is accessible via interface 125 at block 203. In other words, message 501 can be transmitted in response to device 101 determining that access point 107 is accessible at block 203. In these implementations, it is assumed that connection 401 has been established; in other words, when connection 401 is already established when block 203 occurs, it is appreciated that blocks 205, 207 have occurred prior to block 203, and block 209 occurs in direct response to block 203 occurring; otherwise, block 209 occurs in direct response to block 203 occurring, after block 205 occurs.

Message 501 can comprise any suitable data for causing device 103 to access network 105 via access point. For example in some implementations, message 501 comprises credentials 177, as depicted in FIG. 5. However, in other implementations, credentials 177 can be transmitted before message 501, with message 501 and/or after message 501.

In some implementations, user interfaces can be provided at devices 101, 103 to confirm and/or authorize blocks 205, 207, 209. For example, at device 10, prior to transmitting message 501 and/or establishing connection 401, device 101 can provide a user interface prompt (e.g. dialog box) asking for confirmation establish connection 401 and/or transmit message 501. In a non-limiting example, the dialog box can comprise text “Do you want to send access point credentials to device 103?” with options to allow or deny connection 401 and/or transmission of message 501. It is further appreciated that rather than “device 103” a suitable identifier of device 103 could be used. Similarly, a user interface prompt can be provided at device 103 confirming establishment of connection 401. Alternatively, there could be provided user interface options which allow pre-authorization of transmission of credentials 177 by device 101, and/or pre-authorization of device 103 to auto-connect using received credentials from a first device, such as device 101. In some implementations auto-connection can occur only with trusted devices. It should be understood that user interface prompts may include the use of any suitable human machine interface for providing to a user with control over user-selectable options described herein.

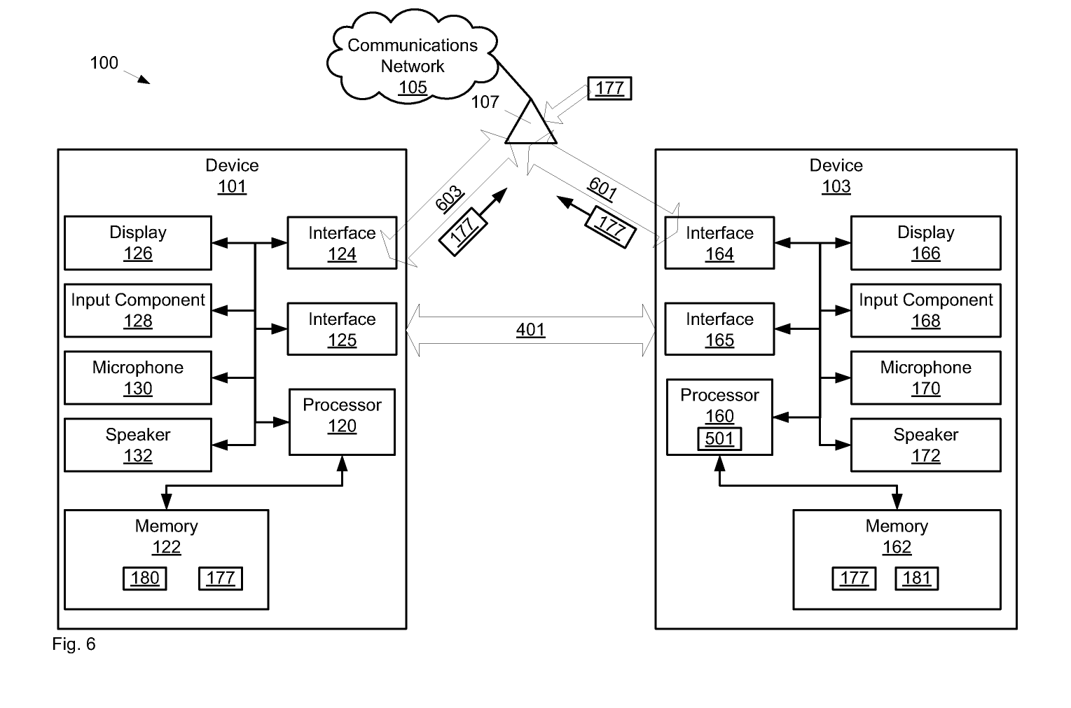

Returning to FIG. 2, and with further reference to FIG. 6, at block 211 message 501 is received at device 103 at interface 165. Message 501 can be processed by processor 160. As previously noted, message 501 is for causing interface 163 to access network 105 via access point 107. Hence, at block 213, device 103 accesses network 105 via access point 107. For example, a connection 601 is established between interface 164 of device 103 and access point 107 using credentials 177.

Further, it is appreciated that connection 601 can be established in response to receiving message 501. Further, it is appreciated that connection 601 can be established by device 103 responsive to receiving message 501.

Furthermore it is appreciated that in some implementations, message 501 is received at device 103 without device 103 requesting message 501. In other implementations, device 103 may request to be notified by device 101 when device 101 detects an access point. For example, device 103 may have a communications session with device 101, over which device 103 makes a standing request for notification from device 101 regarding changes detected by device 101. In this example implementation, device 103 may utilize less resources by relying on device 101 for detecting the presence and credentials associated with accessing newly discovered access points.

Connection 601 between device 103 and access point 107 can be established using credentials 177. In some implementations, credentials 177 and/or a portion thereof, are transmitted to access point 107 from device 193 via interface 164 to authenticate device 103 and/or otherwise assist with establishing connection 601. Furthermore, credentials 177 can be stored at memory 162, for example for later use by device 103 at establishing another connection with access point 107 when connection 601 is disconnected.

In specific non-limiting implementations where access point 107 comprises a WiFi access point, connection 601 can comprise a WiFi connection.

Returning to FIG. 2, and again with reference to FIG. 6, in some implementations, at block 215 device 101 also accesses network 105 via access point 107 by establishing a connection 603 with access point 107, similar to connection 601, in a manner similar to that described above with reference to block 213. However, device 101 can access network 105 via access point 107 one or more of: before transmitting message 501 to device 103; when transmitting message 501 to device 103; and, after transmitting message 501 to device 103. In other words, block 215 can occur before block 209 (but after block 201), concurrently with block 209 and/or after block 209, as depicted.

In relation to method 200 at device 101, device 103 may implement method 220. In method 220, device 103 is caused to communicate with network 105 via access point 107. Consider the following scenario: a traveller, with at least two WiFi and Bluetooth™ enabled devices, for example a PDA and a tablet, arrives at a WiFi enabled hotel room allowing access to a communications network. The devices connect via Bluetooth™. A password for the WiFi access point is also provided in the hotel room. A first one of the devices detects the SSID of the WiFi access point and the traveller then enters the password into the first device. Method 200 occurs in the first device, which automatically transmits a message (similar to message 501) to the second device via Bluetooth™ causing method 220 to occur in the second device to access a communications network via the WiFi access point. The first device can also access the communications network via the WiFi access point. Hence, by receiving credentials for the WiFi access point at a first one of the two devices, both devices can access the communications network via the WiFi access point. Indeed, the second device can be caused to access the communications network via the WiFi access point without having to request credentials and/or instructions and/or a message from the first device, or without requiring a second manual input of the credentials on the second device by the traveller.

In some implementations, device 101 can be configured to: when credentials 177 for accessing network 105 via access point 107 have not been previously received at device 103, transmit message 501 to device 103 with credentials 177. In other implementations, device 101 can be configured to when credentials 177 have been previously received device 103, transmit message 501 to device 103 without credentials 177.

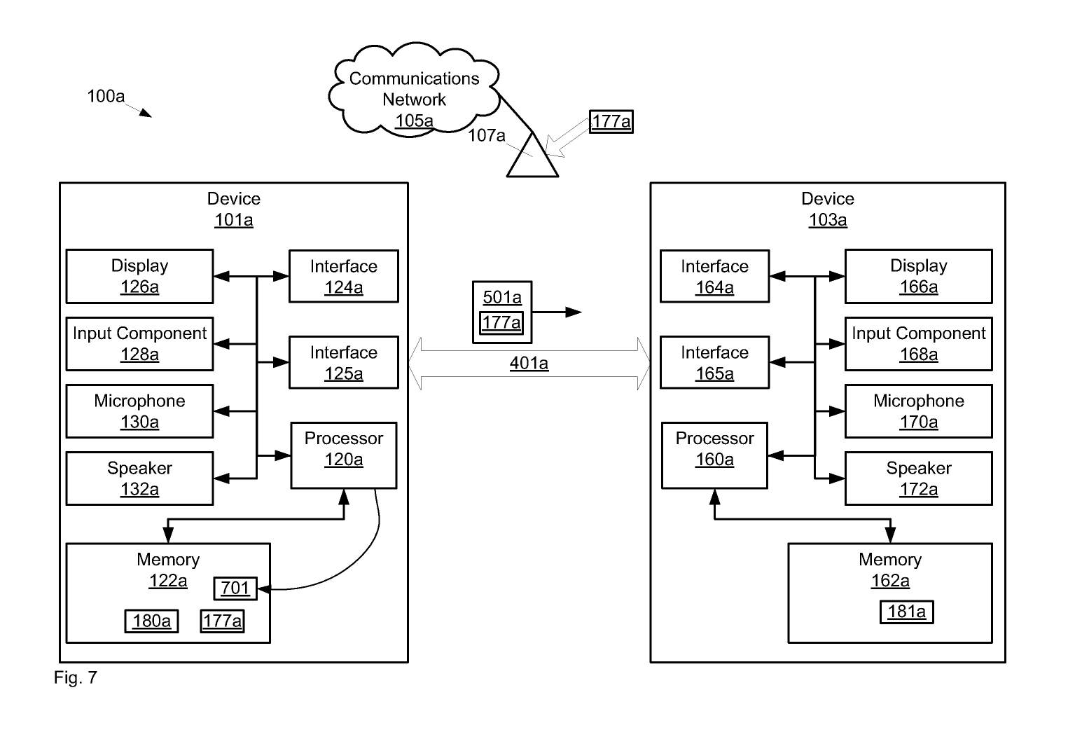

For example, attention is directed to FIG. 7 which depicts a system 100a which is substantially similar to system 100 as depicted in FIG. 5, with like with like elements having like numbers however with an “a” appended thereto. Hence, system 100a comprises a device 101a, a device 103a, a network 105a, and an access point 107a associated with credentials 177a. Device 101a comprises a processor 120a interconnected with a memory 122a storing an application 180a and credentials 177a, a first communications interface 124a, a second communications interface 125a, a display 126a and an input component 128a, and optionally a microphone 130a and speaker 132a. Similarly device 103a comprises a processor 160a interconnected with a memory 162a storing a application 181a, a first communications interface 164a, a second communications interface 165a, a display 166a and an input component 168a, and optionally a microphone 170a and speaker 172a. It is assumed in FIG. 7 that method 200 and second method 220 are being implemented therein and that blocks 201 to 207 have already occurred such that a connection 401a has been established between devices 101a, 103a; hence FIG. 7 depicts block 209 of method 200 being implemented therein.

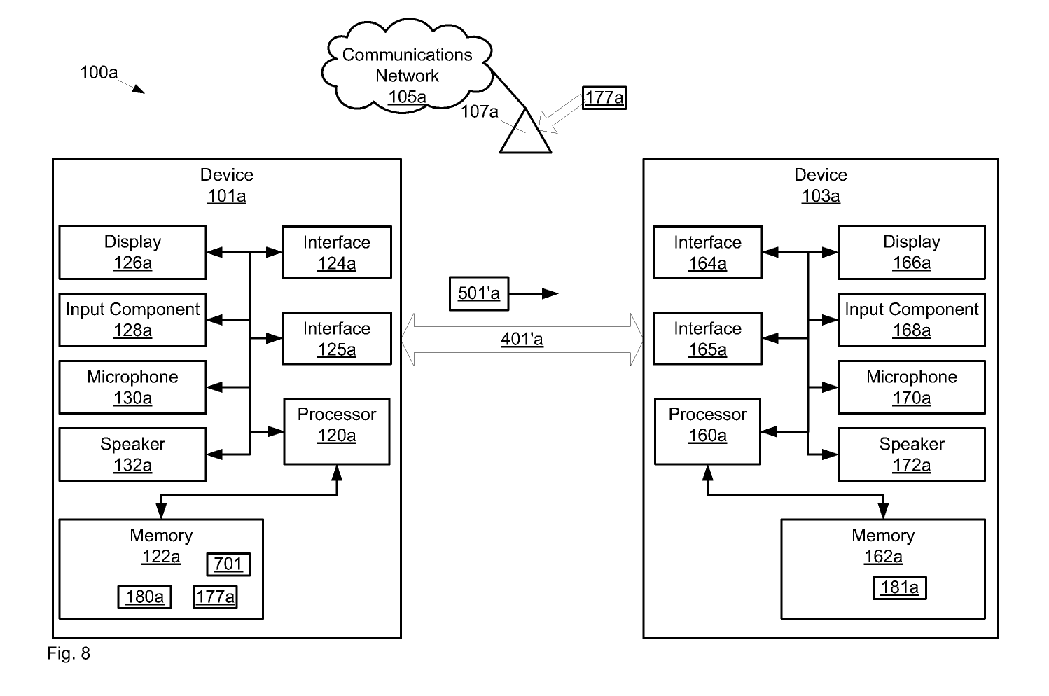

However, in these implementations, when message 501a is transmitted to device 103a with credentials 177a, processor 120a stores a record 701 of transmitting credentials 177a to device 103a. It is again assumed in FIG. 8 that method 200 and second method 220 are implemented therein and that blocks 201 to 207 have already occurred such that a connection 401a has been established between devices 101a, 103a; hence FIG. 8 depicts block 209 of method 200 occurring therein. However, in these implementations, it is assumed that credentials 177a have been previously received at device 103a and hence record 701.

In further implementations, device 101a can determine whether credentials 177a have been have been previously received at device 103a when connection 401a, or a similar connection between interfaces 125a, 165a is established. For example, before message 501a is transmitted, device 103a can transmit a record of credentials stored at device 103a on connection 401, which can be used to generate record 701. The record of credentials stored at device 103a transmitted to device 101a can be requested by device 101a or transmitted to device 101a by device 103a. The record of credentials stored at device 103a can be transmitted to device 101a when connection 401 is established, for example in a handshaking process.

Attention is next directed to FIG. 8, which is substantially similar to FIG. 7, with like elements having like numbers. As in FIG. 7, it is assumed in FIG. 8 that method 200 and second method 220 are implemented therein and that blocks 201 to 207 have already occurred such that a connection 401′a has been established between devices 101a, 103a, similar to connection 401a; hence FIG. 8 depicts block 209 of method 200 occurring therein. However, in these implementations, it is further appreciated that record 701 is already stored at memory 122a; for example method 200 and second method 220 have previously been performed as in FIG. 7. Hence, as record 701 is stored at memory 122a, device 101a determines that credentials 177a have been previously received at device 103a, and hence message 501′a, similar to message 501a, is transmitted to device 101a without credentials 177a thereby saving bandwidth on connection 401a.

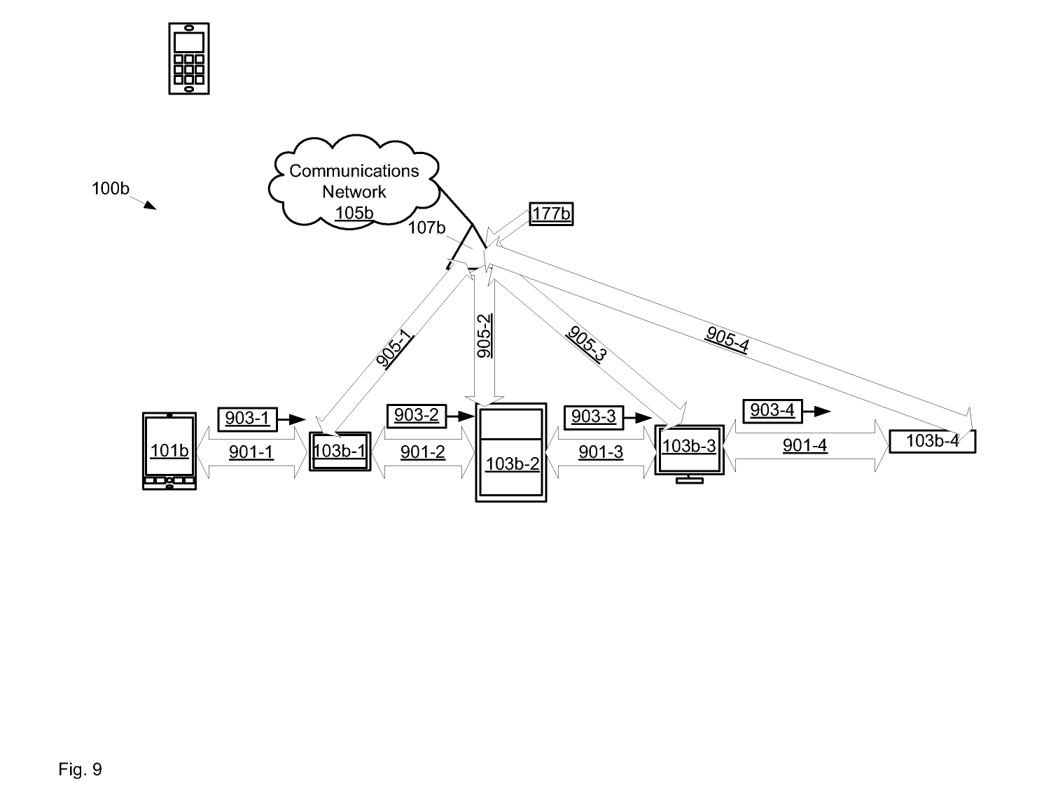

It is further appreciated that method 200 can be repeated at either of devices 101, 101a with any other device similar to devices 103, 103a. Furthermore, method 220 can be repeated at device 103, 103b with any other device similar thereto. For example attention is next directed to FIG. 9 which depicts system 100b, similar to system 100 with like elements having like numbers with a “b” appended thereto. However, system 100b comprises a device 101b similar to device 100, and a plurality of devices 103b-1, 103b-2, 103b-3, 103b-4, referred to collectively hereafter as devices 103b, and generically as a device 103b. This convention will be used elsewhere in the specification. Communications at each device 103b can be similar to device 103 described in relation to previous Figures, however in the example described in FIG. 9 each device 103b can be of a different type. For example, device 103b-1 can comprise a tablet computing device, device 103b-2 can comprise an Internet-enabled appliance, such as a refrigerator, device 103b-3 can comprise an Internet-enabled television, and device 103b-4 can comprise an Internet-enabled digital video recorder (DVR). In any event, it is appreciated that each device 103b comprises at least a processor similar to processor 160, two interfaces each similar to interfaces 164, 165, respectively, and a memory similar to memory 162. It is further appreciated that each device 103b comprise any further components for implementing specialized functions therein, such as computing, appliance, and/or entertainment related functions.

It is yet further appreciated that connections 901-1, 901-2, 901-3, 901-4 can be respectively established between devices 103b, 103b-1, devices 103b-1, 103b-2, devices 103b-2, 103b-3 and devices 103b-3, 103b-4, each connection 901 similar to connection 401 described above. Connections 901-1, 901-2, 901-3, 901-4 are referred to collectively hereafter as connections 901, and generically as a connection 901. Further, while only four devices 103b are depicted in FIG. 9, it is appreciated that system 100b can comprise any suitable number of devices 103b.

In any event, it is appreciated that method 200 and second method 220 may be performed with device 101b as the first device (e.g. device 101) and any one of the devices 103b-1, 103b-2, 103b-3, 103b-4 as the second device (e.g. device 103). In an example description, method 200 is initially performed by device 101b such that message 903-1 (similar to message 501 of previous Figs) is transmitted via connection 901-1 from device 101b to device 103b-1. Second method 220 is performed by device 103b-1 to access communications network 105b via access point 107b using credentials 177b received in message 903-1. Responsive to receiving message 903-1, a connection 905-1 is hence established between device 103b-1 and access point 107b.

It will be appreciated that once device 101b and 103b-1 have the credentials to access communications network 105b via access point 107b, either device 101b or device 103b-1 may further communicate one or more messages to cause other remaining devices 103b-2, 103b-3, 103b-4 to establish a connection with the access point 107b. In an example, method 200 may be performed by device 103b-1 (acting similarly to previously described first device 101) such that a message 903-2 is transmitted from device 103b-1 to device 103b-2 (acting as previously described second device 103) via connection 901-2. Second method 220 may be performed by device 103b-2, such that responsive to receiving message 903-2 a connection 905-2 is established between device 103b-2 and access point 107b.

Continuing in the example depicted in FIG. 9, method 200 may be performed by device 103b-2 such that a message 903-3 is transmitted from device 103b-2 to device 103b-3 via connection 901-3. Second method 220 may be performed by device 103b-3, such that responsive to receiving message 903-3 a connection 905-3 is established between device 103b-3 and access point 107b.

Finally, continuing in the example depicted in FIG. 9, method 200 can occur in device 103b-3 such that a message 903-4 is transmitted from device 103b-3 to device 103b-4 via connection 901-4. Second method 220 may be performed by device 103b-4, such that responsive to receiving message 903-4 a connection 905-4 is established between device 103b-4 and access point 107b. Connections 905-1, 905-2, 905-3, 905-4 may be hereafter referred to collectively as connections 905, and generically as a connection 905.

Each message 903-1, 903-2, 903-3, 903-4 (collectively and individually referred to as message 903) is similar to message 501 and can include credentials 177b. For example credentials 177b can be transmitted with each message 903 depending on whether the receiving device 103b has previously received credentials 177b or not as described above. A first one of several devices 103b-1, 103b-2, 103b-3, 103b-4 (collectively referred to as several devices 103 or individually referred to as each device 103b) may propagate credentials 177b to a second one of the several devices 103b.

Furthermore, each message 903 can be similar to one another such that each message 903 is propagated from a first one of several devices 103b to a second one of several devices 103b, thereby causing the second one of several devices 103b to access network 105b via access point 107b. The iterative performance of methods 200, 220 on the several devices 103b-1, 103b-2, 103b-3, 103b-4 may be used so that credentials are propagated to the several devices and messages 903 cause some or all of the several devices to access network 105b via access point 107b.

Furthermore, one device (either 101b or one of the several devices 103b) can establish a connection 901 with more than one of the several devices 103b, such that the one device can transmit messages 903 to a plurality of the several devices 103b. In some implementations, connections 103b can comprise a mesh network and messages 903 can be transmitted on any suitable connection 901. Further, a subset of the several devices 103b need not access network 105b via access point 107b, but can propagate message 903 to a next one of the several device 103b without necessarily accessing network 105b. For example, a first one of devices 103b can access network 105b via another device 103b with which the first device 103b is in communication.

It is further appreciated that a connection 905 can be established between device 101b and access point 107b, connection 905 similar to connection 603.

Hence, each device 101b, 103b can be caused to establish communications with network 105b via access point 107b. Hence, for example, each device 101b, 103b in a home network can be caused to log into a common access point 107b once one device 101b discovers access point 107b. In this manner, all devices 103b can be provided with credentials 177b, for example when credentials 177b have not been previously received.

Those skilled in the art will appreciate that in some implementations, the functionality of devices 101, 101a, 103, 103a can be implemented using pre-programmed hardware or firmware elements (e.g., application specific integrated circuits (ASICs), electrically erasable programmable read-only memories (EEPROMs), etc.), or other related components. In other implementations, the functionality of 101, 101a, 103, 103a can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

A person of skill in the art will appreciate that the technology disclosed in this description should not be limited by the examples described. Various examples may be described using different terminology without altering the scope of the disclosure. An aspect of the disclosure provides a method executed by user equipment includes determining access credentials needed for the user equipment to access a wireless network, detecting availability of the wireless network, and transmitting the access credentials to a second device via a communications connection different from the wireless network, the access credentials transmitted to the second device to cause the second device to access the wireless network.

Another aspect of the disclosure provides a device comprising: a processor, a first communications interface, and a second communications interface different from the first communications interface, the processor configured to: determine that an access point to a first communications network is accessible via the first communications interface; and transmit a message to a second device connected via the second communications interface, the message for causing the second device to access the first communications network via the access point. It is further appreciated that all aspects disclosed herein are within the scope of present implementations.

A portion of the disclosure of this patent document contains material which is subject to copyright protection. The copyright owner has no objection to the facsimile reproduction by any one of the patent document or patent disclosure, as it appears in the Patent and Trademark Office patent file or records, but otherwise reserves all copyrights whatsoever.

Persons skilled in the art will appreciate that there are yet more alternative implementations and modifications possible, and that the above examples are only illustrations of one or more implementations. The scope, therefore, is only to be limited by the claims appended hereto.

What is claimed is:

1. A device comprising:
a processor, a first communications interface, and a second communications interface different from the first communications interface, the processor configured to:
determine that an access point to a first communications network is accessible via the first communications interface; and
transmit a message to a second device connected via the second communications interface, the message for causing the second device to access the first communications network via the access point.

2. The device of claim 1, wherein the processor is further configured to transmit the message to the second device responsive to determining that the access point is accessible via the first communications interface.

3. The device of claim 1, wherein the processor is further configured to acquire credentials for accessing the first communications network via the access point from a human machine interface of the first device.

4. The device of claim 1, wherein the processor is further configured to transmit the message to the second device with credentials for accessing the first communications network via the access point.

5. The device of claim 1, wherein the message comprises credentials for accessing the first communications network via the access point

6. The device of claim 1, wherein the processor is further configured to: when credentials for accessing the first communications network via the access point have not been previously received at the second device, transmit the message to the second device with the credentials.

7. The device of claim 1, wherein the processor is further configured to: when credentials for accessing the first communications network via the access point have been previously received at the second device, transmit the message to the second device without the credentials.

8. The device of claim 1, wherein the processor is further configured to: connect with the second device via the second communications interface.

9. The device of claim 1, wherein the processor is further configured to connect with the second device via the second communications interface when it is determined that the access point is accessible.

10. The device of claim 1, wherein the processor is further configured to access the first communications network via the access point one or more of:
before transmitting the message to the second device;
when transmitting the message to the second device; and,
after transmitting the message to the second device.

11. The device of claim 1, wherein the processor is further configured to acquire credentials for accessing the first communications network via the access point from one or more of:
the access point,
an input component,
a near field communication, NFC, tag,
a wireless communications network message,
a short message service, SMS, message,
a flash card,
a subscriber identity module, SIM, card, and
a microSD secure digital card.

12. The device of claim 1, wherein the second communications interface comprises a wireless communications interface.

13. A method in a first device, the method comprising:
determining that an access point to a first communications network is accessible via a first communications interface of the first device; and
transmitting a message to a second device connected via a second communications interface that is different from the first communications interface, the message for causing the second device to access the first communications network via the access point.

14. The method of claim 13, wherein the transmitting the message to the second device occurs when it is determined that the access point is accessible via the first communications interface.

15. The method of claim 13, further comprising: when credentials for accessing the first communications network via the access point have not been previously received at the second device, transmitting the message to the second device with the credentials.

16. The method of claim 13, further comprising: when credentials for accessing the first communications network via the access point have been previously received at the second device, transmitting the message to the second device without the credentials.

17. The method of claim 13, further comprising connecting with the second device via the second communications interface when it is determined that the access point is accessible.

18. The method of claim 13, further comprising accessing the first communications network via the access point one or more of:
before transmitting the message to the second device;
when transmitting the message to the second device; and,
after transmitting the message to the second device.

19. A computer program product, comprising a computer usable medium having a computer readable program code adapted to be executed to implement a method in a first device, the method comprising:
determining that an access point to a first communications network is accessible via a first communications interface of the first device; and
transmitting a message to a second device connected via a second communications interface that is different from the first communications interface, the message for causing the second device to access the first communications network via the access point.

20. A device comprising:
a processor, a first communications interface, and a second communications interface different from the first communications interface, the processor configured to:
receive a message from a second device via the second communications interface, the message for causing the first communications interface to access a first communications network via an access point, the message received from the second device without requesting the message; and
access the first communications network via the access point.

21. The device of claim 20, wherein the processor is further configured to, after receiving the message, request credentials for accessing the first communications network via the access point from the second device when the credentials have not been previously received.
